(19) United States
(12) Patent Application Publication
(10) Pub. No.: US 2017/0001300 A1
(43) Pub. Date: Jan. 5, 2017

(54) Storage Device For Tools

(71) Applicant: Wera Werk Hermann Werner GmbH & Co. KG, Wuppertal (DE)

(72) Inventors: Michael Abel, Radevormwald (DE); Dirk Schardt, Solingen (DE); Martin Strauch, Wuppertal (DE)

(21) Appl. No.: 15/204,075

(22) Filed: Jul. 7, 2016

Related U.S. Application Data
(63) Continuation of application No. PCT/EP2014/078657, filed on Dec. 19, 2014.

(30) Foreign Application Priority Data
Jan. 10, 2014 (DE) 102014100232.6

(51) Int. Cl. B25H 3/02; B25H 3/00

(52) U.S. Cl. CPC B25H 3/02; B25H 3/003

(57) ABSTRACT

A device for storing tools, in particular screwdriving tools, having a planar main body which has an inner side and an outer side, wherein holding devices for retaining the tools on the main body are provided on the inner side, wherein the main body is divided up into surface portions by a number of hinges, the surface portions being foldable about the hinges from a tool-removal position, in which the surface portions are located substantially in one plane, into a storage position, in which the outer sides of the surface portions form planar surfaces of a polygonal solid body.

### TECHNICAL FIELD

The invention relates to a device for storing tools.

### BACKGROUND

Devices for storing tools are known from DE 102 52 747 A1, DE 10 2011 054 219, DE 20 2009 012 145 U1, and DE 10 2005 061 185 A1.

Known in particular are bags made out of textile material, which can be rolled up into a storage position from a removal position, in which the planar main body is spread out in a plane.

The object of the invention is to further develop a known tool bag in a user friendly manner.

The object is achieved by the invention indicated in the claims.

### SUMMARY

The device according to the invention has a planar main body, which exhibits an inner side and an outer side. Provided on the inner side are holding devices for retaining the tools on the main body. The main body is divided into surface portions by several hinges. The surface portions can be folded around the hinges comprised of bending lines into a storage position. In the storage position, the surface portions enhance themselves into an outer surface of a solid body. This forms a polygonal solid body consisting of several surfaces, for example two broadside surfaces, two narrow surfaces and two end surfaces. The end surfaces can run parallel to each other, giving the polygonal solid body the shape of a prism. The surface portions of the main body can each form a dimensionally stable and flexible planar body. At least the outer surface can be made out of a textile material, making the device haptically appealing. Preferably involved is a soft textile, so that the closed or open device can also be placed on sensitive surfaces, for example the bodies of motor vehicles. As a result of the bending lines, the surface portions hinged together can be placed not just on a planar floor surface. They can also be placed on a free surface, for example a curved surface. In the removal position, the individual surface portions connected with each other in an articulated manner can conform to the surface contour of the substrate like tank tracks. The stiffness of the walls is determined in particular by the stiffness of plastic insertion plates, which are preferably sewn between two textile layers. The two textile layers can be connected directly to each other along the hinges, for example with a seam. The insertion plates can be equipped with magnets, so that the open device is held against a steel substrate by magnetic force. The magnets incorporated in the insertion plates can also be used to fix the device in its closed position. The end faces of the polygonal solid body can be sealed by straps secured to the main body. The marginal edge of the end face can consist of the marginal edge of a hem. The main body can be erected in its storage position on this edge comprised of the hem. An end surface can also be comprised of several straps. The several straps then enhance each other to form an essentially flatly running end face. The tools are secured to the inner side of the surface portions with holding devices, for example consisting of plastic. Gaps remain next to a tool. These gaps allow a user to grab the tools. The gaps are preferably large enough to offer enough space for fingertips therein. In the storage position, these gaps are engaged into by portions of tools that are allocated to other surface portions, in particular those that are adjacent or, in the storage position, opposing. The arrangement selected for the tools is such that the gaps between or next to the tools in the storage position are filled up, or at least partially filled up, by portions of other tools. If the device preferably designed as a tool bag is closed, tools of adjacent or opposing bag sides engage into the gaps, so as to largely fill them out. It is viewed as advantageous that the tools be arranged so as to provide the best possible overview in the open state, while the bag exhibits minimal storage dimensions in the closed state. In particular, it is provided that the broadside surface portions carry holding devices spaced a distance apart from the bending lines. This results in free spaces into which tools secured to the inner sides of the narrow surface portions can enter while closing the device. The tools secured to narrow surface portions can exhibit a width that essentially corresponds to the distance measure between the inner sides of the broadside portions that face each other in the storage position. For example, a ratchet can be secured to a narrow surface portion, whose ratchet head is only a little narrower than the width of the broadside portion. Nuts can be secured to the inner side of the opposing narrow surface portion. Each nut here rests on a holder allocated thereto, which can be made out of plastic. The nut with the largest wrench width has a diameter that is only slightly smaller than the width of the narrow surface portion. In particular, it is provided that elongated tools, such as shaft extensions for a ratchet or the ratchet itself be situated parallel to the bending lines. Shorter tools, for example bits or nuts, are situated with their axes transverse to the direction in which the bending lines extend. In particular, the device according to the invention is a textile tool bag, which consists of two textile material layers sewn together along the bending line. The circumferential marginal edge of the two textile material layers is closed with the use of hemming tape. The straps forming the end face surfaces are secured to one of the broadside portions by means of the hemming tape. The stiffening elements preferably fabricated out of plastic and formed by planar bodies are inserted into the spaces of the textile layers separated from each other by seams and in particular by the seams forming the bending lines. The holders can be comprised of textile or plastic, in particular soft or hard plastic, loops into which the tools can be inserted. It is especially advantageous for the insertion plates or several portions of a uniform insertion plate be joined together by spring webs, which when not stressed hold the insertion plates or their portions in a plane. The webs are bent while closing the tool bag, in particular by 90°. They then deliver a spring force that causes the tool bag to spontaneously fold open when its closure is opened. In a preferred further development, the tool bag exhibits an insert body that stiffens at least two, preferably all surface portions. The planar body exhibits slits in the area of the hinges. The respective area between a slit and the outer marginal edge then comprises a spring web. The insert body can be a planar body consisting of a resilient plastic material exhibiting a plurality of slits running parallel to each other, which are spatially allocated to the hinges. The planar body pocketed in a textile jacket forms webs/bridges in the areas adjoining the slits. The textile layers are joined together by seams, wherein the seams run through the slits.

The invention relates to a further development of the storage device for tools, in which the tools are screwdriver inserts, in particular screwdriver bits exhibiting an axial length of 25 mm and a ¼ hexagonal section, with which the bits are inserted into insertion openings of holders. To this end, it is provided that at least two surface portions each exhibit one or more holding devices. The holding devices can consist of plastic, and be joined with the inner surfaces of the storage device, for example adhesively bonded thereto. Each of the holding devices has a plurality of straight rows that are spaced apart from each other by free spaces, and each exhibit several insertion openings for the screwdriver inserts. The rows of different holding devices are offset relative to each other in such a way that the screwdriver inserts inserted into the insertion openings of the one holding device plunge into the free spaces of the other holding device while closing the device in the storage position.

### BRIEF DESCRIPTION OF THE DRAWINGS

Exemplary embodiments of the invention will be explained below based on the attached drawings. Shown on:

FIG. 1 is a top view of a textile tool bag in a first exemplary embodiment in the open removal position;

FIG. 2 is the textile tool bag viewed in the direction of arrow II on FIG. 1;

FIG. 3 is a perspective view of the open tool bag;

FIG. 4 is a perspective view of the open tool bag, wherein a narrow surface portion 21 is moved into a 90° position relative to a broadside portion 20, so that the head of a ratchet 13 engages into a free space 27;

FIG. 5 is a perspective view, in which another narrow surface portion 19 is moved into a 90° position relative to a broadside portion 20, so that nuts 7 secured to the narrow surface portion 19 plunge into a free space 28 of the broadside portion 20;

FIG. 6 is the tool bag in its closed position;

FIG. 7 is the tool bag in the closed position with narrow surface 19 removed viewed in the direction of arrow VII on FIG. 6;

FIG. 8 is the tool bag with narrow side 21 removed viewed in the direction of arrow VIII on FIG. 6;

FIG. 9 is the tool bag with removed surface portions 18, 22 viewed in the direction of arrow IX on FIG. 6;

FIG. 10 is the section according to line X-X on FIG. 8, but with all surface portions;

FIG. 11 is the section according to line XI-XI on FIG. 8 with all surface portions;

FIG. 12 is the section according to line XII-XII on FIG. 1;

FIG. 13 is a depiction according to FIG. 1 of a second exemplary embodiment, tool holders not fitted;

FIG. 14 is the stiffening insert of the exemplary embodiment depicted on FIG. 13;

FIG. 15 is a third exemplary embodiment with the storage device in an open position;

FIG. 16 is a section according to line XVI-XVI on FIG. 15 in the closed position;

FIG. 17 is a fourth exemplary embodiment of the invention in the open position;

FIG. 18 is the section according to line XVIII-XVIII on FIG. 17 in the closed depiction;

FIG. 19 is a fifth exemplary embodiment of the invention in an open position, and

FIG. 20 is the exemplary embodiment depicted on FIG. 19 in a closed position, cut along the line XX-XX on FIG. 19.

### DETAILED DESCRIPTION

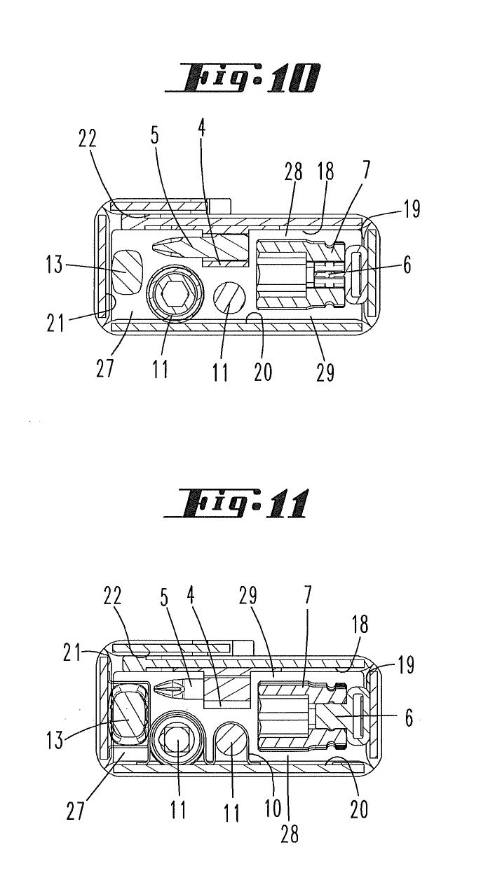

The exemplary embodiment is a device for storing tools, in particular screwdrivers 5, 7, 9, 11, 13. It has a planar main body 1, which exhibits an inner side 2 and an outer side 3. The inner side 2 is comprised of a first textile layer, and the outer side 3 is comprised of a second textile layer. Provided on the inner side 2 are holding devices 4, 6, 8, 10, 12 for retaining the tools 5, 7, 9, 11, 13, which secure the tools 5, 7, 9, 11, 13 to the main body 1. The main body 1 is divided into several surface portions 18, 19, 20, 21, 22 by several hinges 14, 15, 16, 17. The surface portions can be folded, which is shown on FIG. 6. In the storage position, the tools 5, 7, 9, 11, 13 are not visible. Two surface portions 22, 18 regionally overlap, and are secured to each other by means of fastening elements (not shown), e.g., with a button, Velcro or magnet. In the storage position, the textile tool bag resembles a polygonal solid body. In the exemplary embodiment, the polygonal solid body forms a square. The end faces of the square are comprised of straps 26, which are recessed somewhat in relation to the peripheral edge of the main body 1 as the result of re-hemming 31.

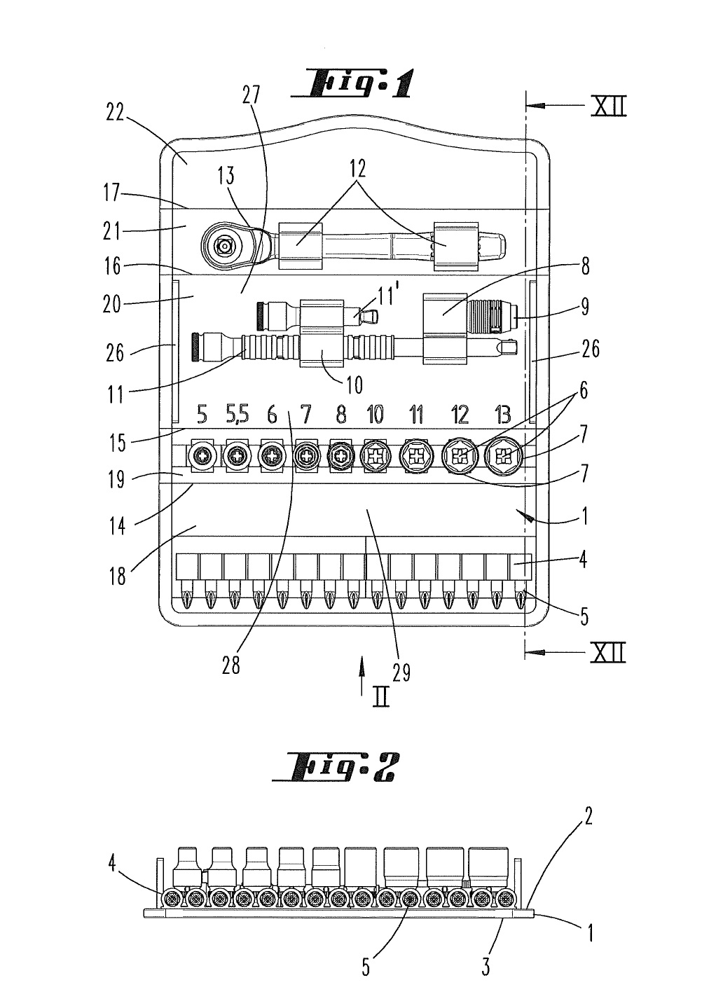

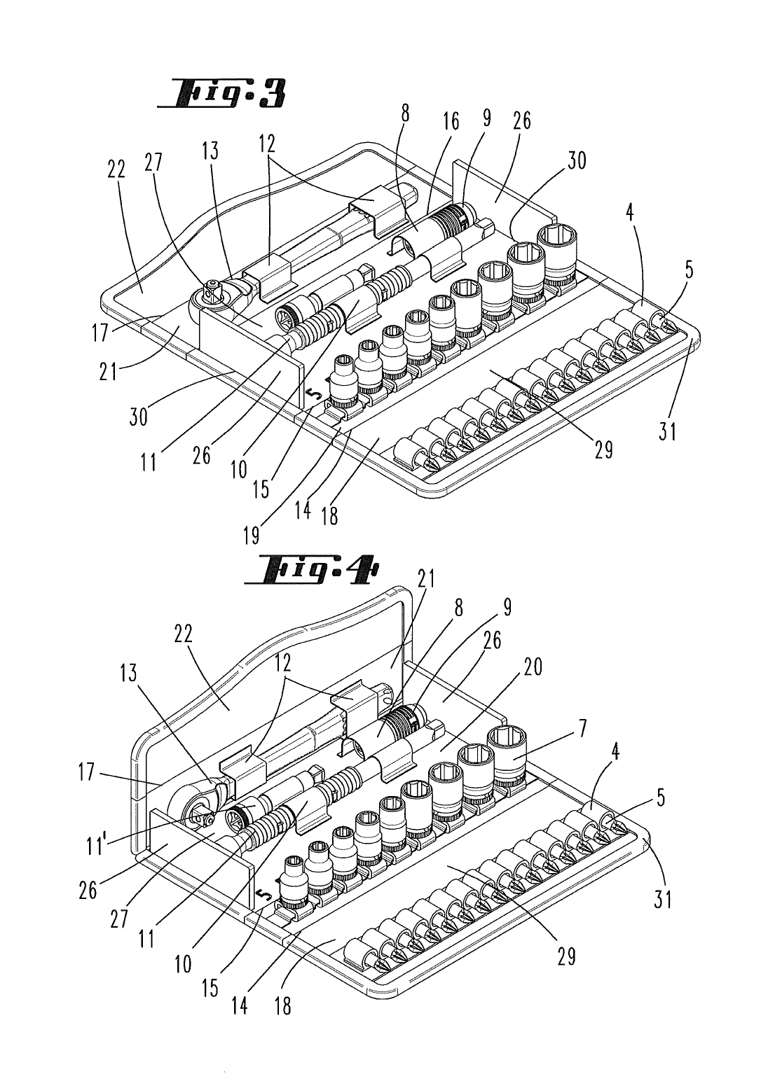

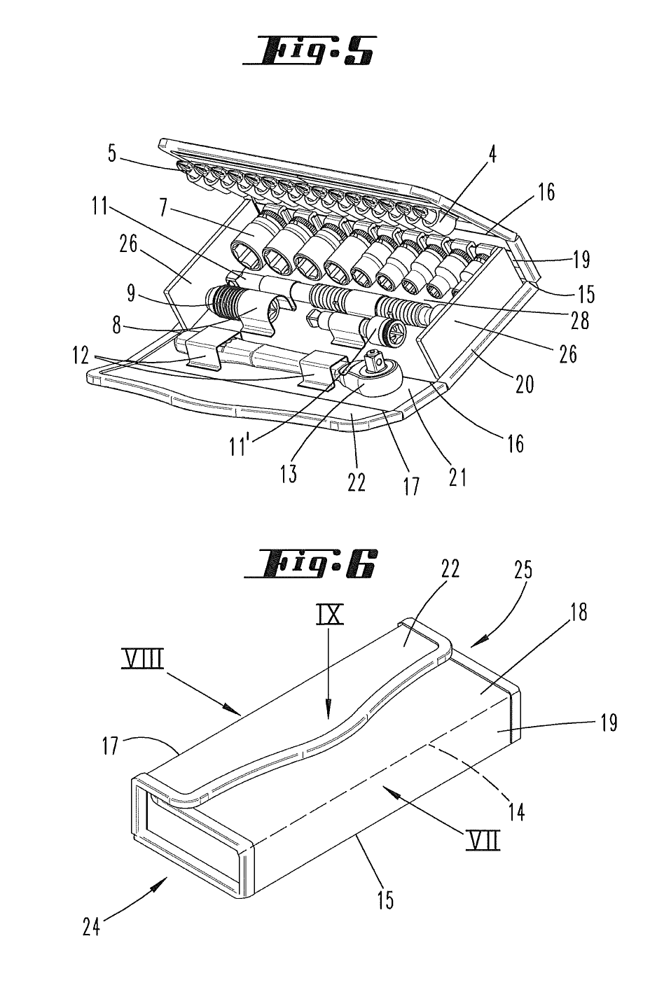

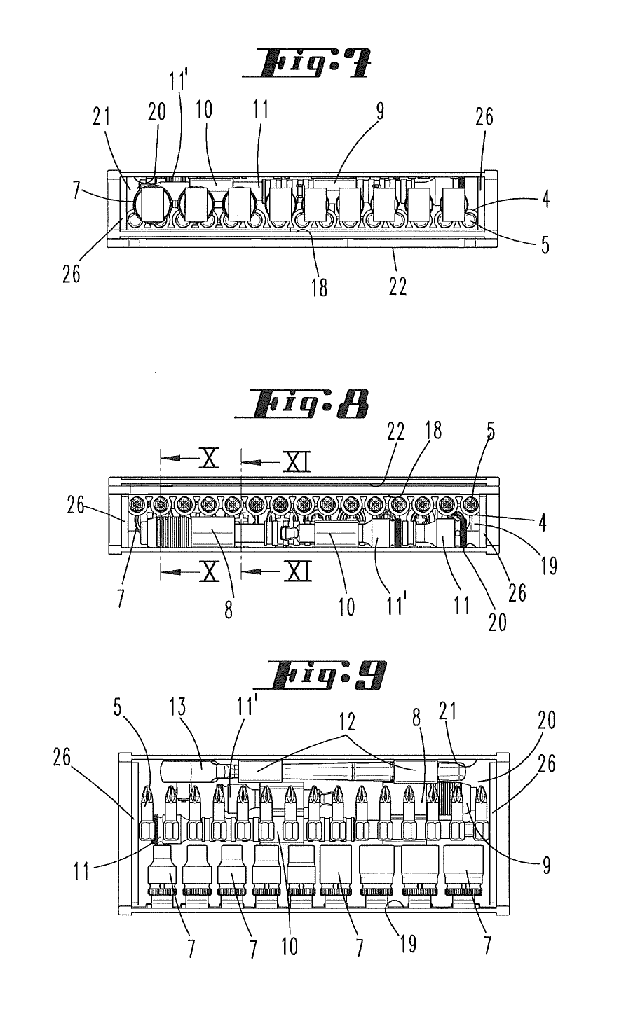

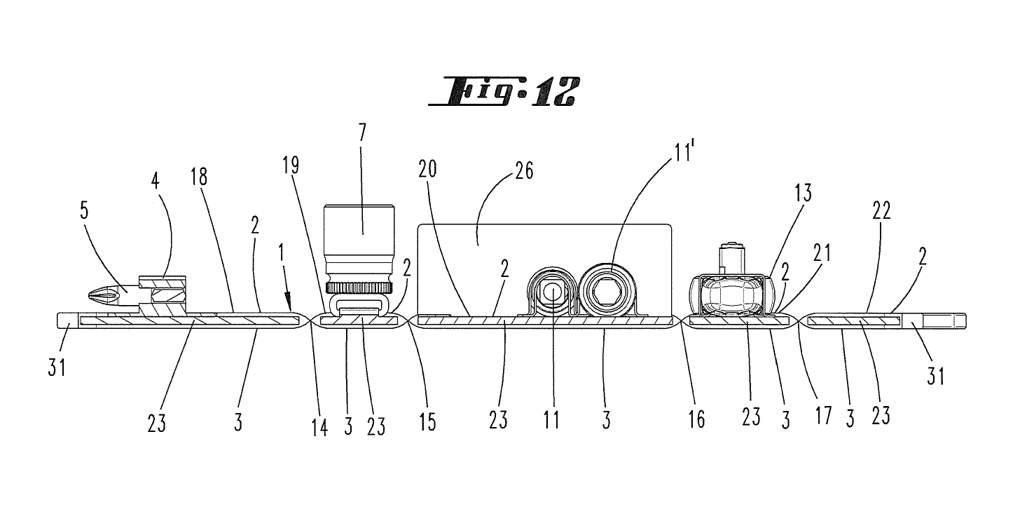

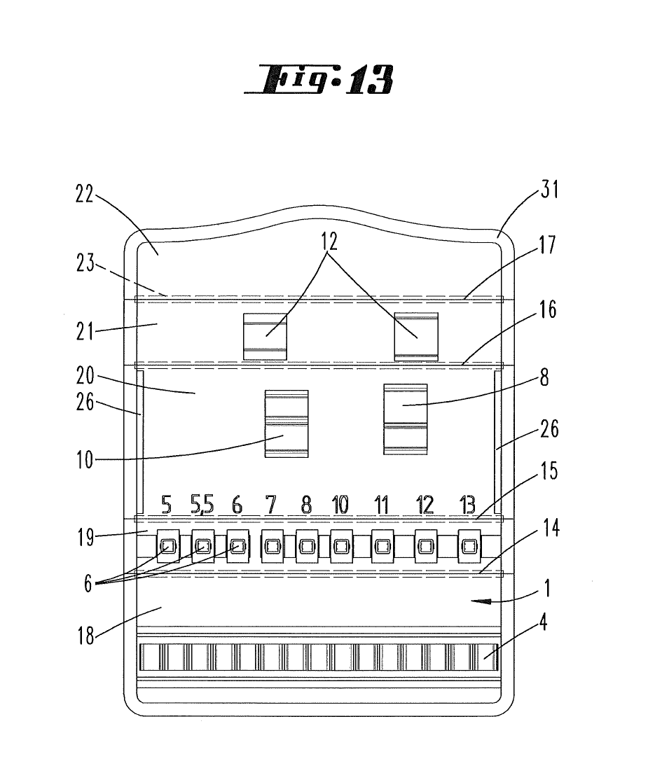

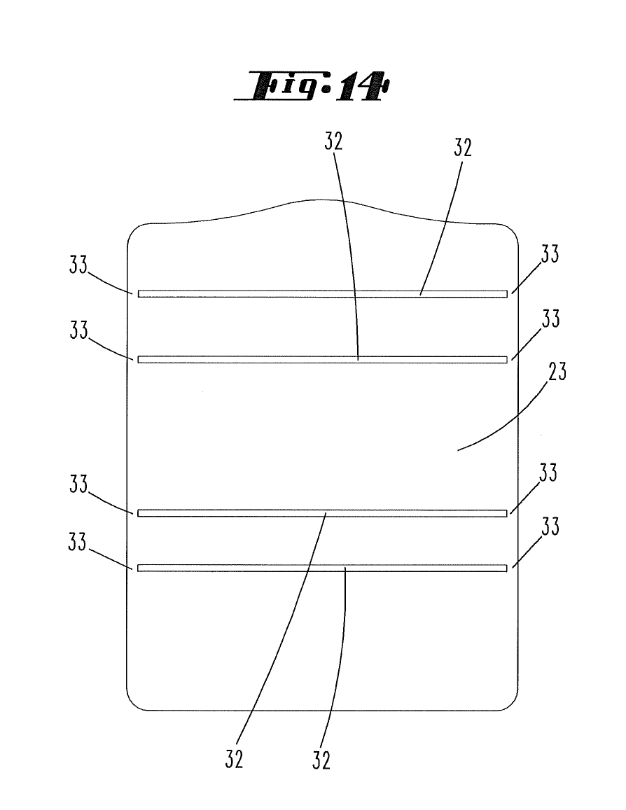

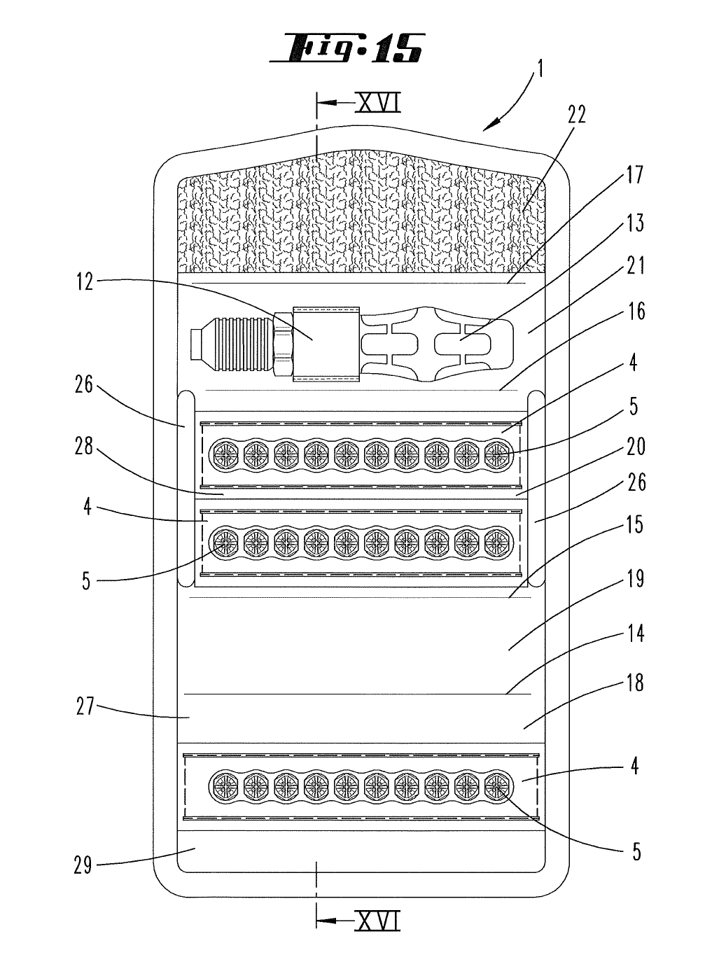

The stiffness of the individual surface portions is ensured by pocketed planar bodies. The planar bodies are insertion bodies with a rectangular cut, wherein the insertion bodies can be made out of plastic. The flexibility of the main body in the area of the hinge lines 14, 15, 16, 17 is achieved by sewing the two textile layers directly to each other there. FIGS. 1 to 11 do not reveal this type of connection, but the sectional view on FIG. 12 does.

The arrangement of the tools inside the device is selected in such a way that the tools 5, 7, 9, 11, 13 provide the best possible overview in the open state, while the bag assumes minimal storage dimensions in the closed state. In particular, it is provided that there be enough space next to the tools and in particular on opposing sides of the tool in the open state, so that a user can there hold the tool between two fingers. This free space can be used for removal and fitting, and is filled up by another tool in the closed state.

Located on the broadside portion 20 is a holding device 10 that forms two loops. A long extension shaft for a ratchet is inserted in one of the loops. A shorter extension shaft for a ratchet is inserted in the other loop. Inserted into another loop 8 is a chuck 9, into which a bit 5 can be inserted. The axes of the shafts 11, 11′ and chuck 9 run parallel to the hinge lines 14, 15, 16, 17. Situated between the shaft 11 and bending line 16 is a free space 27. Located on the opposing side of the shaft 11 between the shaft 11 and hinge line 15 is another free space 27. Rectangular straps 26 are sewn on both opposing free peripheral edges of the broadside portion 20. The narrow surface portion 21 joined with the broadside portion 20 via the hinge line 16 carries a ratchet 13, whose ratchet head has a width only slightly smaller than the width of the narrow surface portion 21. The arm of the ratchet 13 is inserted into two loops 12, and exhibits an axial extension that extends parallel to the hinge lines 14, 15, 16, 17. If the narrow surface portion 21 is moved from the open position shown on FIG. 1 into the position shown on FIG. 4, i.e., around the hinge line 16 by 90°, the head of the ratchet 13 swivels into the free space 27 next to the shaft 11.

The narrow surface portion 19 bordering the broadside portion 20 via the hinge line 15 carries a plurality, specifically nine, nuts 7 that each exhibit a different wrench width. Plastic retaining clips 6 are joined with the inner side of the narrow surface portion 19, on which the nuts 7 are inserted in such a way that their axes extend transverse to the direction in which the hinge lines 14, 15, 16, 17 extend. If the narrow surface portion 19 is swiveled up by 90° from the open position shown on FIG. 1 into the position shown on FIG. 5, the nuts 7 secured to the narrow surface portion 19 are swiveled into the free space 28 next to the shaft 11.

The narrow surface portion 19 is joined with a broadside portion 18 via the hinge 14. The broadside portion 18 carries screwdriver bits 5. Each screwdriver bit 5 is inserted into a holder 4. The holder 4 consists of a loop. A loop body comprises several loops. The loops yield cavities that extend in a direction transverse to the hinge lines 14, 15, 16, 17.

The polygonal portions of the screwdriver bits 15 (not shown) extend into the loops 4, so that the working tips of the bits 5 protrude out of the loops. Free spaces remain between the individual working tips, so that the bits can be gripped between two fingers.

A free space 29 extends between the holder 4 and hinge line 14. If the narrow surface portion 19 is moved into a 90° position relative to the broadside portion 18, the nuts 7 swivel into the free space 29. In the closed state, the free space 28 lies opposite the free space 29.

It is viewed as advantageous that the retaining clips 6 protrude transversely to the surface extension of the inner side 3 in the open state of the device. This makes it easy to fit and remove the nuts.

The closing strap joined with the narrow surface portion 21 via the hinge line 17 is also comprised of a surface portion 22. In the closed state, the surface portion 22 overlaps the surface portion 18.

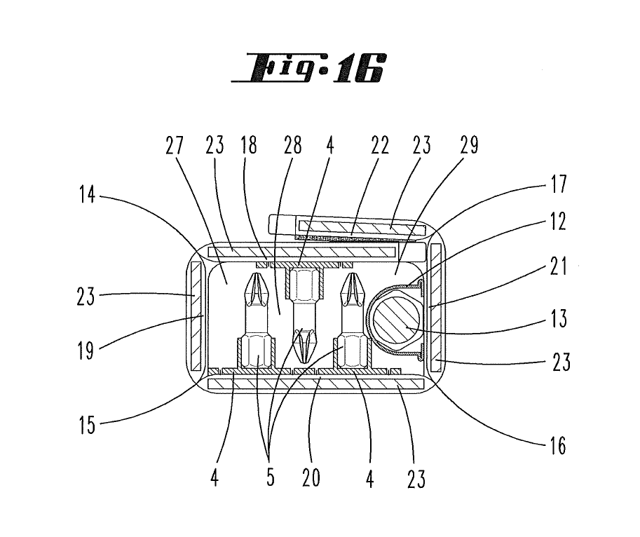

FIGS. 13 and 14 show a second exemplary embodiment, which essentially only differs from the exemplary embodiment shown on FIGS. 1 to 12 by the insertion body 23. A top view of the insertion body is presented on FIG. 14. It consists of a single planar body, which is made out of a flexible plastic. The planar body 23 has four slits 32 that run parallel to each other. The planar body 23 is pocketed between two textile layers. The textile layers are joined together by seams, wherein the seams run through the slits 32. The slits 32 coincide with the hinge lines 14, 15, 16, 17. The slits 32 are completely enclosed, and have a narrow outline. The two longitudinal edges run parallel to each other. Webs 33 are formed between each narrow edge of the slit 32 and the outline contour line of the planar body 32. These material webs form spring webs. When folding the tool bag from the folded-open position shown on FIG. 13 into a closed position, e.g., shown on FIG. 6, the spring webs 33 are bent by 90°. As a result of their spring bias, the tool bag automatically opens into the position shown on FIG. 13 when the closure is opened. The material of the insertion body 23 can be a fiber-reinforced plastic, for example a fiberglass reinforced plastic.

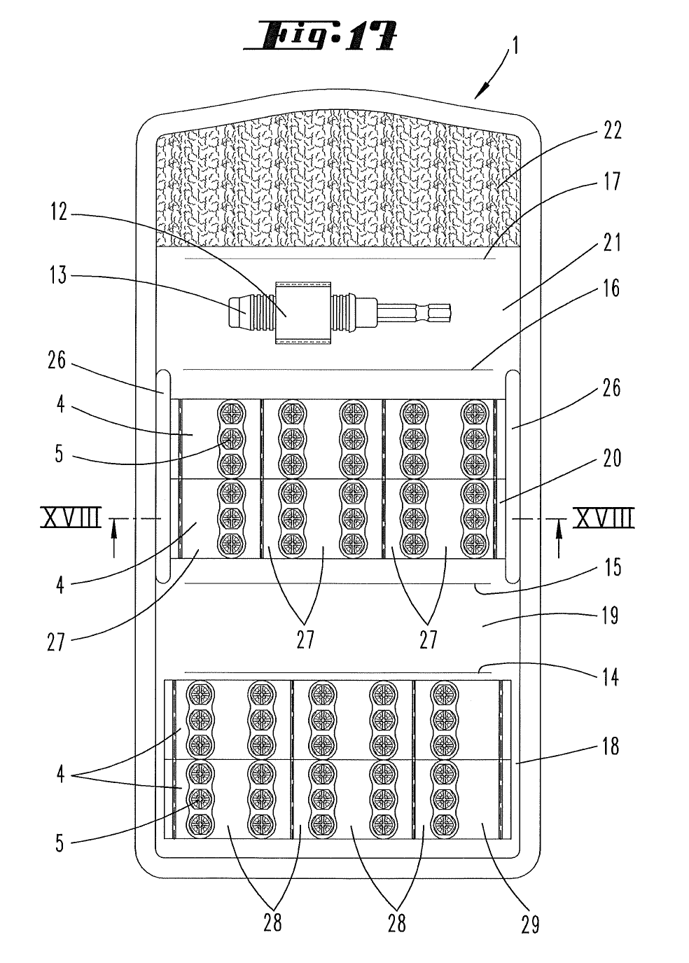

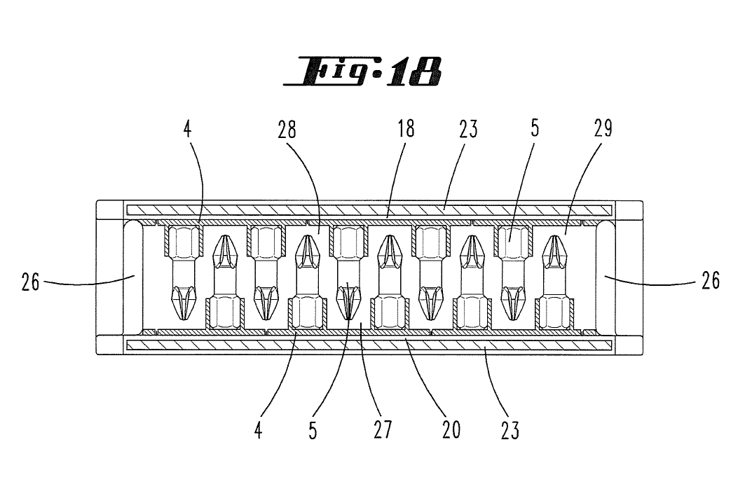

FIGS. 15 and 16 show a third exemplary embodiment of the invention, in which the storage device exhibits a planar main body in the open position, which consists of surface portions 18, 19, 20, 21, 22 joined together via hinge lines 14, 15, 16, 17. The surface portions 18, 20 and 21 are fitted with tools. The narrow surface portion 21 has a fastening strap 21, which holds a screwdriver handle 31 with an insertion chuck. The broadside portion 20 exhibits two holders 4 running parallel to the hinge lines 15, 16 for accommodating bits 5. The holders 4 consist of plastic bodies m with insertion openings for a respective one bit 5. The holders 4 are joined in a planar manner with the inner side of the surface portion 20, which also carries two straps 26 that close narrow sides in the closed position.

Formed in the area of the hinge 16 is a free space 27, into which the screwdriver 13 can swivel in the closed state.

The insertion openings of the holding device 4 for the individual bits 5 are each arranged one behind the other as a row. A free space 28 remains between the two rows, into which a bit row situated on the surface portion 18 engages in the closed state. The surface portion 18 carries a holding device 4 with insertion openings for bits 5. The surface portion 18 carries only a single row of bits. Situated next to the row are free spaces 27, 29, into which the bits resting on the surface portion 20 can swivel in the collapsed state.

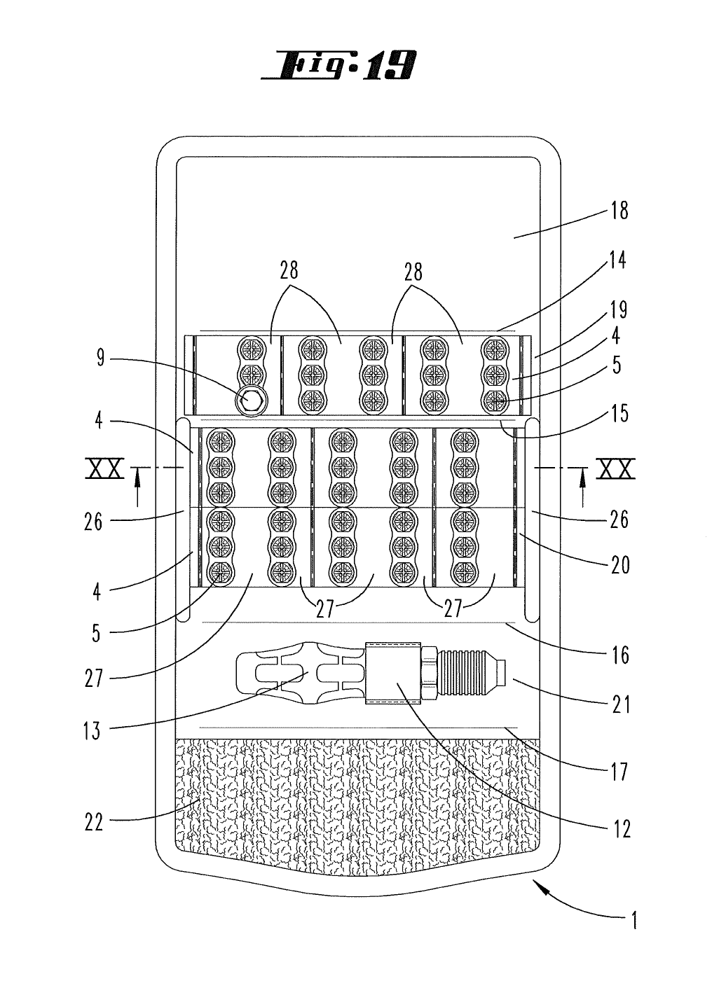

In the fourth exemplary embodiment shown on FIGS. 17 and 18, a narrow side wall 21 carries a chuck 13, which is secured to the narrow side wall by means of a loop 12. This storage device also exhibits surface portions 18, 19, 20, 21, 22, which abut against each other on parallel running hinge lines 14, 15, 16, 17. Two broadside portions 18, 20 lying opposite each other in the closed positions are each fitted with holders 4 made out of plastic for accommodating bits. The holders 4 have insertion openings for a respective one bit. The insertion openings are arranged in rows running transverse to the hinge lines 14, 15, 16. The rows are spaced apart from each other so as to yield free spaces 27, 28 between the rows. When closing the storage device, the bits of the other broadside portion 18, 20 enter into the free spaces 27, 28.

The outer edges of the surface portion 20 each carry a strap 26, which in the closed state forms a side wall of the storage device.

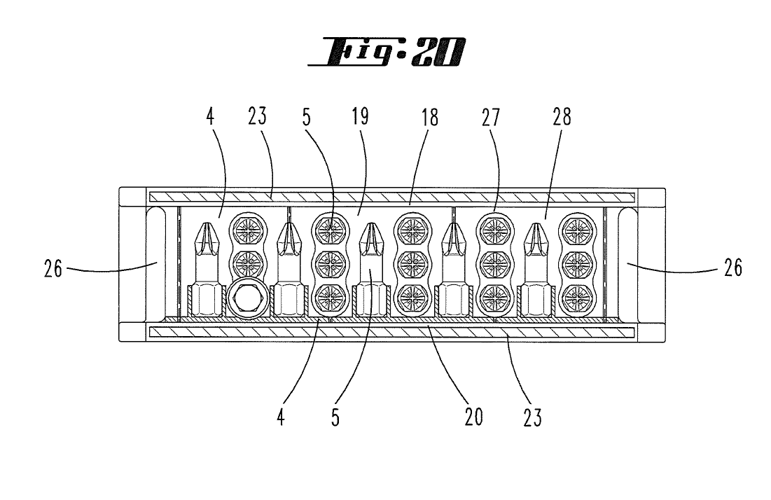

Just as in the case of all other exemplary embodiments, the fifth exemplary embodiment shown on FIGS. 19 and 20 is a screwdriver storage device with a planar main body in the open state. The main body exhibits a textile outer side, and preferably also a textile inner side. The screwdriver 13 is here secured to a narrow side surface 21. The opposing narrow side surface 19 carries a holder 4 for screwdriver bits. The screwdriver bits are arranged in several rows that extend transverse to the alignment of the hinge axes 14, 15. Each insertion opening has three receiving openings for bits. A chuck 9 is inserted in one receiving opening.

The inner side of the broadside portion 20 is fitted with two holding devices 4 running parallel to the hinge lines 14, 15. Each of the two holding devices running parallel to each other exhibits several rows of insertion openings for a respective bit 5. Each row here also contains three insertion openings, wherein a total of six insertion openings lie one behind the other in a direction transverse to the progression of the hinge lines 14. The rows are single-row, so that each bit has two neighbors at most.

Extending between the single-row rows of the storage devices are free spaces 27, 28, into which bits of the surface portion 19 or 20 can plunge while closing the device.

The storage devices shown on FIGS. 15 to 20 have a total of five surface portions 18 to 22. In the closed state, the surface portions 18, 22 abut against each other, to some extent parallel to each other. The surface portion 22 is provided with adhesive agents, which can adhere to the outer side of the surface portion 18 when closing the device.

Especially the parallel, side-by-side arrangement of several, in particular two, holding devices 4 made out of plastic for bits, which in particular are fitted with bits 5, is of inventive importance in the exemplary embodiments shown on FIGS. 15 to 12. A large enough free space 18 is situated between the holding devices 4, so that the bits 4 arranged in the holders can be removed with two fingers. The free space 28 is not just large enough to insert a thumb, but also wide enough that the bits inserted in a holder 4 of another surface portion 18, 19 can enter it.

Further of independent importance is that straps 26 are allocated to the surface portion 20, which exhibits at least one or more holding devices 4 for bits 5 or holding devices 4 fitted with bits 5, wherein these straps form opposing walls of the storage device in a closed state, wherein the straps 26 in particular are flexibly secured to the edges of the surface portion 20, for example sewn or adhesively bonded.

Also of independent importance is the allocation of a handle 13 or some other screwdriver to a narrow surface portion 21, which borders a broad surface portion 20, wherein holders 4 fitted with bits 5 are allocated to a second narrow surface portion 19, which borders the wide surface portion 20.

Further of inventive importance is that a chuck 9 or extension piece is inserted in an insertion opening of a holder 4 allocated to a narrow surface portion 19, and in the closed state of the storage device lies between two rowed holding portions of the holding device 4, which are allocated to the wide surface portion 20 that immediately adjoins the narrow surface portion 19 on a hinge line 15.

Further of inventive importance is that holders 4 allocated to a first surface portion 20 exhibit spaced apart rows of insertion openings for bits 5, and another surface portion 18, 19 exhibits structurally identical holders 4 for bits, whose rowed insertion openings for bits 5 are offset relative to the rowed insertion openings of the holder 4 of the surface portion 20 in such a way that the bits inserted in the insertion openings of the respective holding device 4 plunge into the free spaces 27, 28 of the respective other holding device 4.

The above statements serve to explain the inventions encompassed in totality by the application, which each independently further develop the prior art with at least the following feature combinations.

A device for storing tools, in particular screwdrivers with a planar main body 1, which exhibits an inner side 2 and an outer side 3, wherein holding devices, 4, 6, 8, 10, 12 are provided on the inner side 2 for retaining the tools 5, 7, 9, 11, 13 on the main body 1, wherein the main body 1 is divided by several hinges 14, 15, 16, 17 into surface portions 18, 19, 20, 21, 22, wherein these surface portions 18, 19, 20, 21, 22 can be folded out of a tool removal position, in which the surface portions 18, 19, 20, 21, 22 lie essentially in a single plane, around the hinges 14, 15, 16, 17 and into a storage position, in which the outer sides 3 of the surface portions 18, 19, 20, 21, 22 form planar surfaces of a polygonal solid body.

A device, characterized in that the surface portions 18, 19, 20, 21, 22 of the main body are each stiffened by a dimensionally stable and flexible planar body/planar body portion 23, and in particular at least the outer side 3 of a surface portion 18, 19, 20, 21, 22 is made out of a textile material.

A device, characterized in that the device is shaped like a prism in its storage position, and exhibits a stiffness that makes it possible to erect the device stably on a planar floor surface with each of its surface portions 18, 19, 20, 21, 22 and/or with their end faces 24, 25 that face away from each other and run parallel to each other.

A device, characterized in that the holding devices 4, 6, 8, 10, 12 are arranged in such a way that the tools 5, 7, 9, 11, 13 thereby secured to the main body 1 stiffen the main body 1 in its storage position.

A device, characterized by free spaces 27, 28, 29 between the tools 5, 7, 9, 11, 13 secured to the inner side 2, which in the removal position make it easier to remove the tools, and into which engage tools 7, 13 arranged on other surface portions 19, 21 in the storage position.

A device, characterized in that the inner side 2 and outer side 3 are each made out of a textile, in particular a fabric, which are joined together by seams running along the hinge lines 14, 15, 16, 17, and between which dimensionally stable and flexible planar insertion bodies 23 are situated.

A device, characterized in that, in the removal position, the main body 1 forms an angular, in particular an essentially square surface object with hinge lines 14, 15, 16, 17 running parallel to short peripheral edges.

A device, characterized in that the holding devices are arranged in such a way that elongated tools 11, 13 extend parallel to the hinge lines 14, 15, 16, 17 and/or that the holding devices 4, 6, 8, 12 are arranged in such a way that screwdriver inserts 5, 7, in particular bits or nuts, extend transverse to the progression of the hinge lines 14, 15, 16, 17.

A device, characterized that the hinges form precisely four bending lines 14, 15, 16, 17, and a surface portion 12 near the edge forms a closing strap, which adhesively abuts in a planar manner against a surface portion bordering the edge in a storage position.

A device, characterized in that the narrow side surfaces of the polygonal solid body are each comprised of one or more straps 26, which are joined with a peripheral edge of a broadside surface along a bending line.

A device, characterized in that one or more insertion bodies 23 are fitted with magnets.

A device, characterized by spring webs 33 arranged in the area of the bending lines 14, 15, 16, 17, with which portions of the planar body 23 are joined together, which are preloaded in the storage position and relaxed in the removal position.

A device, characterized in that a plurality, in particular all, surface portions 18, 19, 20, 21, 22, are stiffened by a shared planar body 23, wherein this planar body 23 forms slits 32 in the area of the hinge lines 14, 15, 16, 17 that run parallel thereto.

A device, characterized in that each hinge line 14, 15, 16, 17 is crossed by a respective two webs 33 comprising the narrow side of a slit.

A device, characterized in that a first surface portion 20 exhibits one or more first holding devices 4, and a second surface section 19, 20 exhibits one or more second holding devices 4, wherein each of the first and second holding devices 4 forms a plurality of respective straight, spaced apart rows that run through a free space 27, 28 and exhibit a respective plurality of insertion openings for screwdriver inserts 5, wherein the rows of the first holding device 4 are offset relative to the rows of the second holding device 4 in such a way that, in the storage position, the screwdriver inserts 5 inserted into the insertion openings of the first holding device 4 plunge into the free spaces 28 of the second holding device 4, and the screwdriver inserts 5 inserted into the insertion openings of the second holding device 4 plunge into the free spaces 27 of the first holding device 4.

All disclosed features are essential to the invention (taken individually or also in combination with each other). The disclosure of the invention hereby also incorporates the disclosure content of the accompanying/attached priority documents (copy of the preliminary application) in its entirety, even for the purpose of also including features from these documents into the claims of the present application. The features in the subclaims characterize independent inventive further developments of prior art, in particular to initiate partial applications based upon these claims.

1. A device with screwdrivers stored therein, with a planar main body, which exhibits an inner side and an outer side, wherein the inner side is provided with holding devices for retaining the tools on the main body, wherein the main body is divided into surface portions by several hinges, wherein these surface portions can be folded from a tool removal position, in which the surface portions lie essentially in one plane, around the hinges into a storage position, in which the outer sides of the surface portions form planar surfaces of a polygonal solid body, wherein the surface portions of the main body are stiffened by a respective dimensionally stable and flexible planar body/planar body portion, and in particular at least the outer side of a surface portion is made out of a textile material, wherein the device is shaped like a prism in its storage position, and exhibits a stiffness that makes it possible to erect the device stably on a planar floor surface with each of its surface portions and with their end faces that face away from each other and run parallel to each other, characterized by free spaces between the tools secured to the inner side, which in the removal position make it easier to remove the tools, and into which engage tools arranged on other surface portions in the storage position, wherein first holding devices are arranged in such a way that elongated tools extend parallel to the hinge lines and second holding devices are arranged in such a way that nuts held by them extend transverse to the progression of the hinge lines.

2. The device according to claim 1, characterized in that the second holding devices are arranged on a narrow surface portion, wherein each nut rests on a holder allocated thereto, wherein the nut with the largest wrench width has a diameter that is only slightly smaller than the width of the narrow surface portion.

3. The device according to claim 1, characterized in that in the removal position, the main body forms an angular, in particular an essentially square surface object with hinge lines running parallel to short peripheral edges.

4. The device according to claim 1, characterized in that the holding devices are arranged in such a way that the tools thereby secured to the main body stiffen the main body in its storage position.

5. The device according to claim 1, characterized in that the inner side and outer side are each made out of a textile, in particular a fabric, which are joined together by seams running along the hinge lines, and between which dimensionally stable and flexible planar insertion bodies are situated.

6. The device according to claim 1, characterized in that the hinges form precisely four bending lines, and a surface portion near the edge forms a closing strap, which adhesively abuts in a planar manner against a surface portion bordering the edge in a storage position.

7. The device according to claim 1, characterized in that the narrow side surfaces of the polygonal solid body are each comprised of one or more straps, which are joined with a peripheral edge of a broadside surface along a bending line.

8. The device according to claim 1, characterized in that one or more insertion bodies are fitted with magnets.

9. The device according to claim 1, characterized by spring webs arranged in the area of the bending lines, with which portions of the planar body are joined together, which are preloaded in the storage position and relaxed in the removal position.

10. The device according to claim 1, characterized in that a plurality, in particular all, surface portions, are stiffened by a shared planar body, wherein this planar body forms slits in the area of the hinge lines that run parallel thereto.

11. The device according to claim 10, characterized in that each hinge line is crossed by a respective two webs comprising the narrow side of a slit.

12. A device for storing tools, in particular screwdrivers, with a planar main body, which exhibits an inner side and an outer side, wherein the inner side is provided with holding devices for retaining the tools on the main body, wherein the main body is divided into surface portions by several hinges, wherein these surface portions can be folded from a tool removal position, in which the surface portions lie essentially in one plane, around the hinges into a storage position, in which the outer sides of the surface portions form planar surfaces of a polygonal solid body, characterized in that the surface portions have allocated to them a dimensionally stable and flexible planar insertion body, wherein spring webs are arranged in the area of the hinges, with which portions of the planar body are joined together, and which are preloaded in the storage position and relaxed in the removal position.
